(19) United States
(12) Patent Application Publication
(10) Pub. No.: US 2026/0329418 A1
(43) Pub. Date: Oct. 22, 2026

(54) ELECTRONIC APPARATUS AND CONTROL METHOD THEREOF

(71) Applicants: SAMSUNG ELECTRONICS CO., LTD., Suwon-si (KR); KOREA UNIVERSITY RESEARCH AND BUSINESS FOUNDATION, Seoul (KR)

(72) Inventors: Yunsung JUNG, Suwon-si (KR); Arum CHOI, Suwon-si (KR); Dosung JUNG, Suwon-si (KR); Seunghun YOO, Seoul (KR); Jihoon AN, Seoul (KR); Dogyeong KIM, Seoul (KR)

(73) Assignees: SAMSUNG ELECTRONICS CO., LTD., Suwon-si (KR); KOREA UNIVERSITY RESEARCH AND BUSINESS FOUNDATION, Seoul (KR)

(21) Appl. No.: 19/680,414

(22) Filed: May 18, 2026

Related U.S. Application Data
(63) Continuation of application No. PCT/KR2026/003297, filed on Feb. 27, 2026.

(30) Foreign Application Priority Data
Apr. 16, 2025 (KR) 10-2025-0049587

(51) Int. Cl. G06F 3/0484; G06F 3/01; H04N 9/31

(52) U.S. Cl. CPC G06F 3/0484; G06F 3/011; H04N 9/3194

(57) ABSTRACT

An electronic apparatus includes a projector, a sensor, memory storing instructions, and least one processor. The instructions, when executed by the at least one processor individually or collectively, cause the electronic apparatus to, based on identifying that a user is moving, obtain a walking pattern and a predicted moving path based on a location and a moving direction of the user that are obtained through the sensor, obtain a projection location of a user interface (UI) corresponding to a foot interaction based on the walking pattern and the predicted moving path, and project, by the projector, the UI corresponding to the foot interaction based on the projection location and a location of a dominant foot of the user, wherein the dominant foot of the user is identified based on a use pattern obtained through performing of a function corresponding to the foot interaction.

### CROSS-REFERENCE TO RELATED APPLICATIONS

This application is a by-pass continuation of International Application No. PCT/KR2026/003297, filed on Feb. 27, 2026, which is based on and claims priority to Korean Patent Application No. 10-2025-0049587, filed in the Korean Intellectual Property Office on Apr. 16, 2025, the disclosures of which are incorporated by reference herein in their entireties.

### BACKGROUND

### 1. Field

The disclosure relates to an electronic apparatus and a control method thereof.

### 2. Description of Related Art

Recently, as technologies for artificial intelligence (AI) home robots are developing, technologies for foot interactions for interacting with AI home robots are developing.

An AI home robot is a robot for assisting with a user in various activities while moving in an indoor space. A foot interaction is an operation for interacting with a robot by using a foot motion of a user for a user interface (UI) screen provided by the robot.

However, a problem exists in case a location of a user changes in real time, in a process of providing a UI screen for a foot interaction to a user, the location of at which the user interface is provided is incorrect.

### SUMMARY

According to an aspect of the disclosure, an electronic apparatus includes: a sensor; a projector; memory storing instructions; and at least one processor including processing circuitry, wherein the instructions, when executed by the at least one processor individually or collectively, cause the electronic apparatus to: based on identifying that a user is moving, obtain a walking pattern and a predicted moving path based on a location and a moving direction of the user that are obtained through the sensor, obtain a projection location of a user interface (UI) corresponding to a foot interaction based on the walking pattern and the predicted moving path, and project, by the projector, the UI corresponding to the foot interaction based on the projection location and a location of a dominant foot of the user, and wherein the dominant foot of the user is identified based on a use pattern obtained through performing of a function corresponding to the foot interaction.

The instructions, when executed by the at least one processor individually or collectively, may cause the electronic apparatus to: obtain a first projection area based on the projection location and the location of the dominant foot of the user, and project, by the projector, the UI on one area in a second projection area including an area that is rotated by a predetermined angle in a first direction with respect to the first projection area based on the first projection area and the dominant foot.

The first direction is an outward direction of the dominant foot, and the instructions, when executed by the at least one processor individually or collectively, may cause the electronic apparatus to: identify a height of the user through the sensor, and project, by the projector, a UI corresponding to a first size based on the height of the user on one area in the second projection area centered around the location of the dominant foot.

The first projection area may be based on a motion range of the dominant foot based on a remaining foot of the user, and the second projection area may be wider than the first projection area.

The instructions, when executed by the at least one processor individually or collectively, may cause the electronic apparatus to: apply a weight to each foot of the user based on the use pattern, and based on the weight for a first foot of the user corresponding to a predetermined value, identify the first foot as the dominant foot.

The instructions, when executed by the at least one processor individually or collectively, may cause the electronic apparatus to: based on a single button corresponding to a foot interaction being included in the UI, apply a first weight to a foot corresponding to the single button, based on a plurality of buttons corresponding to a foot interaction being included in the UI, apply a second weight to a foot of the user, other than a foot adjacent to a first button, corresponding to the first button among the plurality of buttons, and based on an adjustable UI corresponding to a foot interaction being included in the UI, apply a third weight to a foot of the user corresponding to the adjustable UI.

The instructions, when executed by the at least one processor individually or collectively, may cause the electronic apparatus to: obtain the projection location through an artificial intelligence model based on data corresponding to a user location obtained through the sensor, and the artificial intelligence model may be trained to obtain the walking pattern and the predicted moving path based on the location and the moving direction of the user, and obtain the projection location based on the walking pattern and the predicted moving path.

The instructions, when executed by the at least one processor individually or collectively, may cause the electronic apparatus to, based on a single button corresponding to a foot interaction being included in the UI, project, by the projector, a UI corresponding to the single button on an area corresponding to a center location of the dominant foot.

The instructions, when executed by the at least one processor individually or collectively, may cause the electronic apparatus to: based on a plurality of buttons corresponding to a foot interaction being included in the UI, obtain priorities corresponding to the plurality of buttons based on the use pattern, and project, by the projector, a button having a high priority among the plurality of buttons on an area corresponding to a center location of the dominant foot.

The instructions, when executed by the at least one processor individually or collectively, may cause the electronic apparatus to: obtain a time spent corresponding to a movement from a current location to a predicted location of the user based on the predicted moving path, and provide a notification corresponding to the time spent and the moving direction.

According to an aspect of the disclosure, a control method for an electronic apparatus, includes: based on identifying that a user is moving, obtaining a walking pattern and a predicted moving path based on a location and a moving direction of the user that are obtained by a sensor of the electronic apparatus; obtaining a projection location of a user interface (UI) corresponding to a foot interaction based on the walking pattern and the predicted moving path; and projecting, by a projector of the electronic apparatus, the UI corresponding to the foot interaction based on the projection location and a location of a dominant foot of the user, wherein the dominant foot of the user is identified based on a use pattern obtained through performing of a function corresponding to the foot interaction.

The control method may further include: obtaining a first projection area based on the projection location and the location of the dominant foot of the user; and projecting, by the projector, the UI on one area in a second projection area including an area that is rotated by a predetermined angle in a first direction with respect to the first projection area based on the first projection area and the dominant foot.

The first direction may be an outward direction of the dominant foot, and the control method may further include: identifying a height of the user through the sensor, and projecting a UI corresponding to a first size based on the height of the user on one area in the second projection area centered around the location of the dominant foot.

The first projection area may be based on a motion range of the dominant foot based on a remaining foot of the user, and the second projection area may be wider than the first projection area.

According to an aspect of the disclosure, a non-transitory computer-readable storage medium stores computer instructions which, when executed by a processor of an electronic apparatus, may cause the electronic apparatus to perform operations including: based on identifying that a user is moving, obtaining a walking pattern and a predicted moving path based on a location and a moving direction of the user; obtaining a projection location of a user interface (UI) corresponding to a foot interaction based on the walking pattern and the predicted moving path; and projecting the UI corresponding to the foot interaction based on the projection location and a location of a dominant foot of the user, wherein the dominant foot of the user is obtained based on a use pattern obtained through performing of a function corresponding to the foot interaction.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an operation of an electronic apparatus according to one or more embodiments;

FIG. 2 is a block diagram illustrating a configuration of an electronic apparatus according to one or more embodiments;

FIG. 3 is a block diagram illustrating a detailed configuration of an electronic apparatus according to one or more embodiments;

FIG. 4 is a diagram illustrating a process of identifying a predicted moving path of an electronic apparatus according to one or more embodiments;

FIG. 5 is a diagram illustrating a process of identifying a walking pattern of a user an electronic apparatus according to one or more embodiments;

FIG. 6 is a diagram illustrating a process of identifying a projection location of a UI screen of an electronic apparatus according to one or more embodiments;

FIG. 7 is a diagram illustrating a process of identifying a projection location by using an artificial intelligence model of an electronic apparatus according to one or more embodiments;

FIG. 8 is a flowchart and FIG. 9 is a diagram illustrating a process of identifying a dominant foot of an electronic apparatus according to one or more embodiments;

FIG. 10 is a diagram illustrating a process of identifying a projection area of a UI screen of an electronic apparatus according to one or more embodiments;

FIG. 11 is a diagram illustrating a method of projecting a UI screen including a single button of an electronic apparatus according to one or more embodiments;

FIG. 12 is a diagram illustrating a method of projecting a UI screen including a plurality of buttons of an electronic apparatus according to one or more embodiments;

FIG. 13 is a diagram illustrating a process of adjusting a size of a UI screen of an electronic apparatus according to one or more embodiments;

FIG. 14 is a diagram illustrating a process of providing information corresponding to time spent and a moving direction of an electronic apparatus according to one or more embodiments;

FIG. 15 is a flowchart illustrating a method of providing a UI screen of an electronic apparatus according to one or more embodiments; and

FIG. 16 is a flowchart illustrating a method of operating an electronic apparatus according to one or more embodiments.

### DETAILED DESCRIPTION

As terms used in various embodiments of the disclosure, general terms that are currently used widely were selected as far as possible, in consideration of the functions described in the disclosure. However, the terms may vary depending on the intention of those skilled in the art who work in the pertinent field or previous court decisions, or emergence of new technologies, etc. Also, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

In addition, in the disclosure, expressions such as “have,” “may have,” “include,” and “may include” denote the existence of such characteristics (e.g., elements such as numbers, functions, operations, and components), and do not exclude the existence of additional characteristics.

Further, the expression “at least one of A or B” should be interpreted to mean any one of “A” or “B” or “A and B.”

Also, the expressions “first,” “second” and the like used in the disclosure may describe various elements regardless of any order and/or degree of importance. Further, such expressions are used only to distinguish one element from another element, and are not intended to limit the elements.

The description in the disclosure that one element (e.g., a first element) is “(operatively or communicatively) coupled with/to” or “connected to” another element (e.g., a second element) should be interpreted to include both the case where the one element is directly coupled to the another element, and the case where the one element is coupled to the another element through still another element (e.g., a third element).

Also, singular expressions include plural expressions, as long as they do not mean differently in the context. In addition, in the disclosure, terms such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

Further, in the disclosure, “a module” or “a part” performs at least one function or operation, and may be implemented as hardware or software, or as a combination of hardware and software. In addition, a plurality of “modules” or “parts” may be integrated into at least one module and implemented as at least one processor, except “a module” or “a part” that needs to be implemented as specific hardware.

Also, in the disclosure, the term “user” may refer to a person who uses an electronic apparatus or an apparatus used by the person.

Hereinafter, embodiments of the disclosure will be described in detail with reference to the accompanying drawings.

According to one or more embodiments, an electronic apparatus 100 may identify walking pattern of a user and a dominant foot of the user, and provide a user interface (UI) screen for interacting with the electronic apparatus 100 to the user. Here, the electronic apparatus 100 may be a mobile electronic apparatus including a projector. The electronic apparatus 100 may be implemented as various electronic apparatuses such as a mobile robot, a robot cleaner, an automated guided vehicle (AGV), an autonomous mobile robot (AMR), a social robot, a projector, a portable projector, a tablet, a mobile device, a laptop, etc.

According to an embodiment, the electronic apparatus 100 may include a display. Specifically, the electronic apparatus 100 may directly display an obtained image or content on the display.

According to an embodiment, the electronic apparatus 100 may not include a display, but instead may be connected with an external display device, and transmit an image or a content stored in the electronic apparatus 100 to the external display device.

The electronic apparatus 100 may transmit an image or a content to the external display device together with a control signal for controlling such that the image or the content is displayed on the external display device. Here, the external display device may be connected with the electronic apparatus 100 through a communication circuit 170 or an input/output interface 190. For example, the electronic apparatus 100 may not include a display such as a set top box (STB).

According to an embodiment, the electronic apparatus 100 may include a small display that can display only simple information such as text information. The electronic apparatus 100 may transmit an image or a content to the external display device via wire or wirelessly through the communication circuit 170, or transmit them to the external display device through the input/output interface 190.

According to an embodiment, the electronic apparatus 100 may project a UI screen for a foot interaction on a floor or ground surface through a projection part or projector 120. A foot interaction may be a motion of the user for interacting with the electronic apparatus 100 by using a foot motion. When the electronic apparatus 100 projects a UI screen on the floor or ground surface, the user may interact with the electronic apparatus 100 by using a foot motion for at least one of a plurality of buttons included in the UI screen.

The electronic apparatus 100 may identify a location and a movement of a foot through a sensor 110, and receive a user input based on a location on the UI screen corresponding to the location of the foot. As an example, the electronic apparatus 100 may identify a location of a foot of the user through an infrared (IR) sensor or a camera, and receive a user input based on locations of UI elements included in the UI screen and the location of the foot.

A foot interaction is not limited to the above, and may be referred to as a gesture interaction, a contactless interaction, and a foot touch interaction, but it will be generally referred to as a foot interaction in the disclosure.

The UI screen for a foot interaction may be a user interface that can be projected on the bottom by the electronic apparatus 100 and can be manipulated by the user through a foot motion. The UI screen for a foot interaction may include a plurality of UI elements such as buttons, menus, adjustable UI elements, slides, etc.

According to an embodiment, if it is identified that the user is moving, the electronic apparatus 100 may move to the location of the user and project a UI screen through the projector 120. The electronic apparatus 100 may identify the location and the moving direction of the user through the sensor 110, and identify a predicted moving path of the user. The electronic apparatus 100 may move to the predicted moving path and project the UI screen on the predicted location of the user.

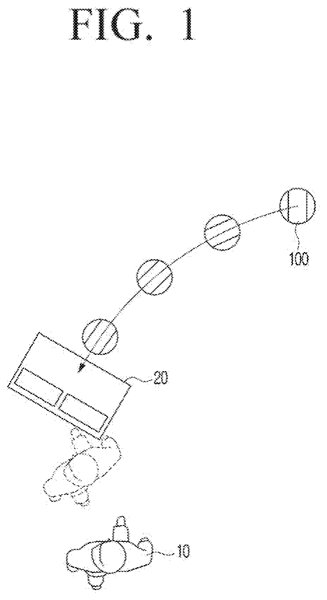

Referring to FIG. 1, the electronic apparatus 100 may identify the location and the moving direction of the user 10 through the sensor 110. The electronic apparatus 100 may identify the moving direction of the user 10 based on at least one of the direction of the torso or the direction of the feet of the user 10. The electronic apparatus 100 may identify a predicted moving path based on the real time location and the moving direction of the user 10, and project the UI screen 20 on the predicted moving path.

However, in case the location of the user is changed in real time, the location of the UI screen projected by the electronic apparatus 100 may be incorrect. For example, although the electronic apparatus 100 identified a projection location of the UI screen on the predicted moving path, and projected the UI screen on the identified projection location, as the location of the user is changed, a foot interaction of the user through the UI screen may be difficult.

Also, even if the electronic apparatus 100 projects the UI screen on the identified projection location, in case the UI screen is not located within a motion range of the user's foot, a foot interaction of the user through the UI screen may be difficult.

Hereinafter, various embodiments wherein the electronic apparatus 100 identifies a projection location of a UI screen based on a walking pattern and a predicted moving path of the user, and identifies a dominant foot of the user, and provides a UI screen based on the projection location and the location of the dominant foot will be explained with reference to the drawings.

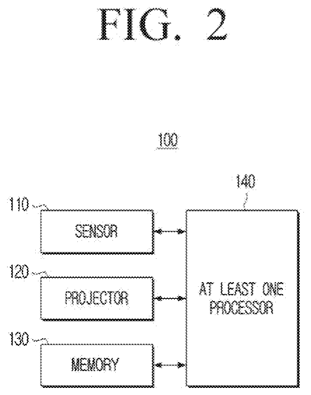

FIG. 2 is a block diagram illustrating a configuration of an electronic apparatus according to one or more embodiments.

According to FIG. 2, the electronic apparatus 100 includes a sensor 110, a projector 120, memory 130, and at least one processor 140. However, embodiments of the disclosure are not limited thereto, and the electronic apparatus 100 may be implemented in a form wherein some components were excluded, or implemented in a form wherein other components are further included.

The sensor 110 is a component for identifying a user while moving in a space. The sensor 110 may include at least one among a LiDAR sensor, a depth camera, an inertial measurement unit (IMU) sensor, a Time of Flight (ToF) sensor, a vision sensor, an optical sensor, an RGB sensor, an image sensor, an infrared sensor, an ultrasonic sensor, a gyro sensor, an acceleration sensor, and a proximity sensor.

A LiDAR sensor may project rays (e.g., laser, near-infrared rays, visible rays, ultraviolet rays, etc.) in directions of 360 degrees in the surroundings, and detect lights reflected by various ambient objects (e.g., a wall, furniture, home appliances, etc.), and output sensing information for obtaining information regarding distances from the ambient objects. A depth camera is a sensor that senses depth data by projecting laser or infrared rays on an external object, and then receiving the returning rays by a stereo camera and stereoscopically measuring the distance from the external object. An IMU sensor is a sensor for detecting movements of an electronic apparatus, and may include at least one of a geomagnetic sensor, an acceleration sensor, or a gyro sensor. A ToF sensor may measure a distance from an external object by outputting a signal such as laser, and then using the time when a reflected signal thereof is received (a Time of Flight).

The projector 120 is a component for projecting a UI screen for a foot interaction. The projector 120 may include a light source, at least one lens, or a reflector, etc. The projector 120 may project an image by using one projection method among a cathode-ray tube (CRT) method, a liquid crystal display (LCD) method, a digital light processing (DLP) method, and a laser method.

The projector 120 may perform various functions according to control by the processor 140. For example, the projector 120 may adjust a focus of an image according to a distance from a floor or ground surface (e.g., a projection distance), or perform a keystone correction function. The keystone correction function means a function of correcting a distorted image. For example, if a distortion of an image occurs in a left-right direction, the projector 120 may perform a horizontal keystone correction, and if a distortion of an image occurs in an up-down direction, the projector 120 may perform a vertical keystone correction. Also, in case the corners of an area are out of balance, the projector 120 may perform a quick corner keystone correction for correcting this.

The memory 130 may store at least one instruction, data, programs, etc. necessary for operations of the electronic apparatus 100. As an example, the memory 130 may store a projection location identified based on a walking pattern and a predicted moving path of the user.

The memory 130 may be implemented in a form of memory embedded in the electronic apparatus 100, or implemented in a form of memory that can be attached to or detached from the electronic apparatus 100 according to the use of stored data. For example, in the case of data for driving the electronic apparatus 100, the data may be stored in memory embedded in the electronic apparatus 100, and in the case of data for an extended function of the electronic apparatus 100, the data may be stored in memory that can be attached to or detached from the electronic apparatus 100.

In the case of memory embedded in the electronic apparatus 100, the memory may be implemented as at least one of volatile memory (e.g., dynamic RAM (DRAM), static RAM (SRAM), or synchronous dynamic RAM (SDRAM), etc.) or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash, etc.), a hard drive, or a solid state drive (SSD)).

The memory 130 may be implemented as a single memory that stores data generated in various operations according to the disclosure, but is not limited thereto, and the memory 130 may also be implemented to include a plurality of memories that respectively store different types of data, or respectively store data generated in different steps.

The at least one processor 140 controls the overall operations of the electronic apparatus 100. Specifically, the at least one processor 140 may be connected with each component of the electronic apparatus 100, and control the overall operations of the electronic apparatus 100. For example, the at least one processor 140 may be electrically connected with the sensor 110, the projector 120, and the memory 130, and control the overall operations of the electronic apparatus 100. The at least one processor 140 may include a processing circuit, and may consist of one or a plurality of processors.

The at least one processor 140 may perform the operations of the electronic apparatus 100 according to the various embodiments by executing the at least one instruction stored in the memory 130.

The at least one processor 140 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor 140 may control one or a random combination of the other components of the electronic apparatus, and perform an operation related to communication or data processing. The at least one processor 140 may execute one or more programs or instructions stored in the memory. For example, the at least one processor 140 may perform the method according to one or more embodiments of the disclosure by executing the one or more instructions stored in the memory.

In case the method according to one or more embodiments of the disclosure includes a plurality of operations, the plurality of operations may be performed by one processor, or performed by a plurality of processors. For example, when a first operation, a second operation, and a third operation are performed by the method according to one or more embodiments, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor).

The at least one processor 140 may be implemented as a single core processor including one core, or it may be implemented as one or more multicore processors including a plurality of cores (e.g., multicores of the same kind or multicores of different kinds). In case the at least one processor 140 is implemented as multicore processors, each of the plurality of cores included in the multicore processors may include internal memory of the processor such as cache memory, on-chip memory, etc., and a common cache shared by the plurality of cores may be included in the multicore processors. Also, each of the plurality of cores (or some of the plurality of cores) included in the multicore processors may independently read a program instruction for implementing the method according to one or more embodiments of the disclosure and perform the instruction, or the plurality of entire cores (or some of the cores) may be linked with one another, and read a program instruction for implementing the method according to one or more embodiments of the disclosure and perform the instruction.

In case the method according to one or more embodiments of the disclosure includes a plurality of operations, the plurality of operations may be performed by one core among the plurality of cores included in the multicore processors, or they may be performed by the plurality of cores. For example, when the first operation, the second operation, and the third operation are performed by the method according to one or more embodiments, all of the first operation, the second operation, and the third operation may be performed by a first core included in the multicore processors, or the first operation and the second operation may be performed by the first core included in the multicore processors, and the third operation may be performed by a second core included in the multicore processors.

In the embodiments of the disclosure, the processor may mean a system on chip (SoC) wherein at least one processor and other electronic components are integrated, a single core processor, a multicore processor, or a core included in the single core processor or the multicore processor. Also, here, the core may be implemented as a CPU, a GPU, an APU, a MIC, a DSP, an NPU, a hardware accelerator, or a machine learning accelerator, etc., but embodiments of the disclosure are not limited thereto. Hereinafter, the at least one processor 140 will be referred to as the processor 140, for the convenience of explanation.

According to an embodiment, if it is identified that the user is moving, the processor 140 may identify a walking pattern and a predicted moving path of the user based on a location and a moving direction of the user who is moving that were obtained through the sensor 110.

The walking pattern of the user may be a pattern for a repetitive movement that appears while the user is walking. The walking pattern may include information about a cycle from the moment when one foot touched the ground until the same foot touches the ground again, and information about a distance between the feet that touched the ground.

The predicted moving path may be a moving path identified based on a real time location of the user and a moving direction of the user. For the predicted moving path, a location of an obstacle (e.g., furniture, a wall) in a space may also be considered.

According to an embodiment, the processor 140 may obtain a projection location of a user interface (UI) corresponding to a foot interaction based on the walking pattern and the predicted moving path of the user. The processor 140 may identify a projection location for projecting the UI screen through the projector 120 based on the walking pattern and the predicted moving path of the user. The projection location may be an area or a point on the space.

According to an embodiment, the processor 140 may identify a dominant foot between the two feet of the user based on a foot interaction use pattern of the user that was obtained while performing a foot interaction with the electronic apparatus 100.

The foot interaction use pattern may be information about a pattern that the user performed a foot interaction through the UI screen. The foot interaction use pattern may include information about log data that the user performed an interaction through the UI screen.

The foot interaction use pattern may include interaction information regarding each of the two feet of the user based on a type of a UI screen. For example, in case the user performed a foot interaction with the right foot for a UI screen including a single button, the foot interaction use pattern may include interaction information regarding the right foot.

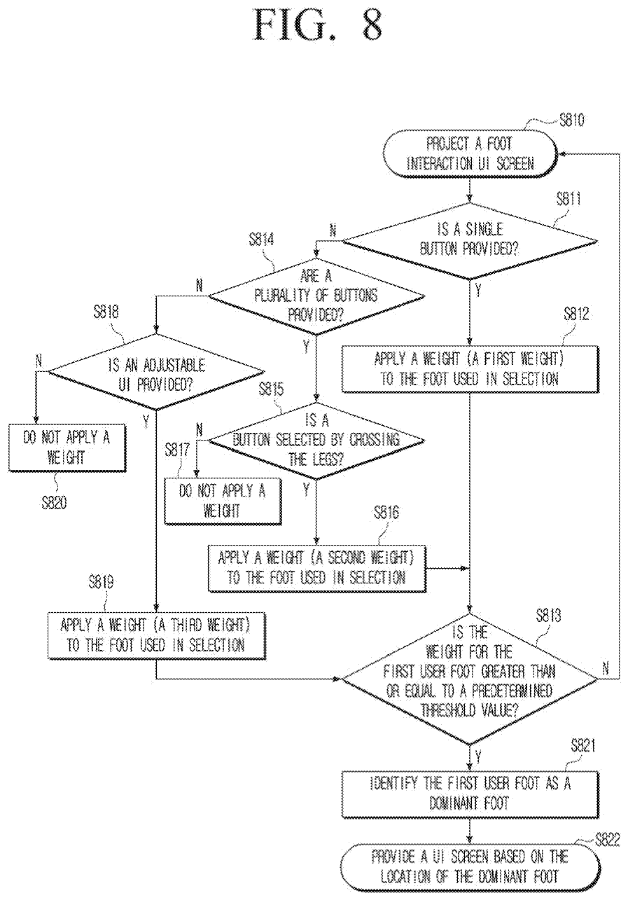

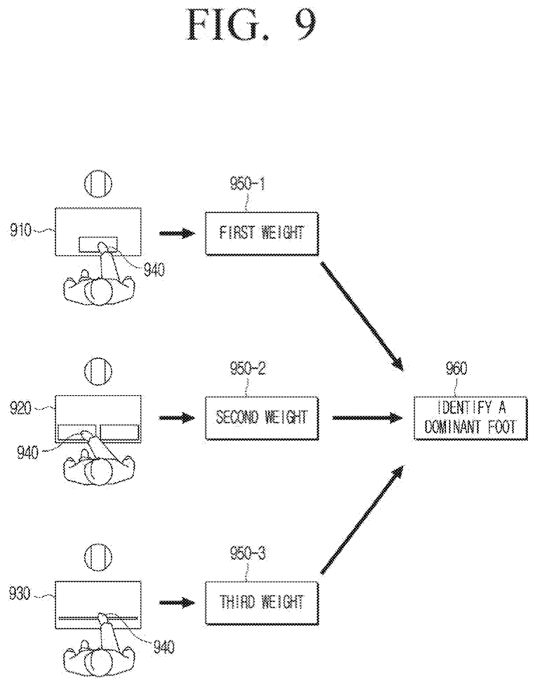

The dominant foot may be a foot that is mainly used in a foot interaction between the two feet of the user. According to an embodiment, the dominant foot may be a foot that is characterized by being obtained based on a use pattern obtained through performing of a function corresponding to a foot interaction. For example, in case the user performs a foot interaction with the UI screen by mainly using the right foot, the right foot may be a dominant foot. A method of identifying a dominant foot between the two feet of the user will be described in detail in FIG. 8.

According to an embodiment, the processor 140 may project a UI screen for performing a foot interaction with the electronic apparatus 100 through the projector 120 based on a projection location and the location of the dominant foot.

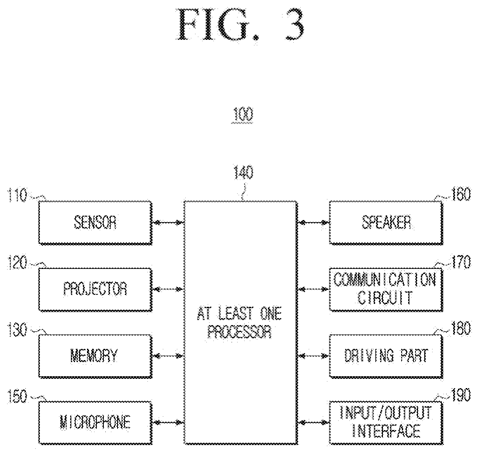

FIG. 3 is a block diagram illustrating a detailed configuration of an electronic apparatus according to one or more embodiments.

According to FIG. 3, the electronic apparatus 100 includes a sensor 110, a projector 120, memory 130, at least one processor 140, a microphone 150, a speaker 160, a communication circuit 170, a driving part 180, and an input/output interface 190. Among the components illustrated in FIG. 3, regarding components overlapping with the components illustrated in FIG. 2, detailed explanation will be omitted.

The microphone 150 is a component for receiving input of a user voice or other sounds, and converting them into audio data. The processor 140 may control the projector 120 based on a user voice signal received through the microphone 150.

The speaker 160 may convert a digital acoustic signal processed at the processor 140 into an analog acoustic signal, amplify the signal, and output it. For example, the speaker 160 may include at least one speaker unit, a D/A converter, an audio amplifier, etc. that can output at least one channel. For example, the speaker 160 may output information corresponding to a caller for a received call and the intent of calling.

The communication circuit 170 may include wired or wireless input/output interfaces (or, input/output terminals) according to various standards. The communication circuit 170 may be a component that performs communication with various types of external devices according to various types of communication methods. The communication circuit 170 may include a wireless communication module or a wired communication module. Here, each communication module may be implemented in a form of at least one hardware chip.

The communication circuit 170 may include various interfaces such as a high-definition multimedia interface (HDMI), a mobile high-definition link (MHL), a universal serial bus (USB), a display port (DP), a Thunderbolt, a video graphics array (VGA) port, an RGB port, a D-subminiature (D-SUB), a digital visual interface (DVI), Bluetooth, Zigbee, a wired/wireless local area network (LAN), a wide area network (WAN), Ethernet, IEEE 1394, AES/EBU (Audio Engineering Society/European Broadcasting Union), Optical, Coaxial, etc.

The driving part 180 is a component for moving the body of the electronic apparatus 100. The driving part 180 may include components such as a plurality of wheels, a driving motor for rotating each of the plurality of wheels, a gear, a shaft, etc. The plurality of wheels are provided on the lower side or the side surface of the body of the electronic apparatus 100, and support the body of the electronic apparatus 100 from the floor or ground surface. When the driving motor operates, and the driving force is transmitted to the plurality of wheels and each wheel gets to rotate, the electronic apparatus 100 may be moved by a frictional force between the floor or ground surface and the wheels. Other than the above, the driving part 180 may vary the rotation speed of at least one wheel among the plurality of wheels when changing the direction, or adjust alignment directions of the wheels differently. According to the type of the electronic apparatus 100, the characteristics of the space wherein the electronic apparatus 100 is located (e.g., the roughness of the floor or ground surface, the frictional force, etc.), a continuous track, etc. may be used instead of the wheels.

The input/output interface 190 may be any one interface among a high-definition multimedia interface (HDMI), a mobile high-definition link (MHL), a universal serial bus (USB), a display port (DP), a Thunderbolt, a video graphics array (VGA) port, an RGB port, a D-subminiature (D-SUB), and a digital visual interface (DVI).

The input/output interface 190 may input or output at least one of an audio signal or a video signal. Depending on implementation examples, the input/output interface 190 may include a port inputting or outputting only audio signals and a port inputting or outputting only video signals as separate ports, or it may be implemented as one port that inputs or outputs both audio signals and video signals.

The input/output interface 190 may be connected with the communication circuit 170. The input/output interface 190 may transmit information received from an external device to the communication circuit 170, or transmit information received through the communication circuit 170 to the external device.

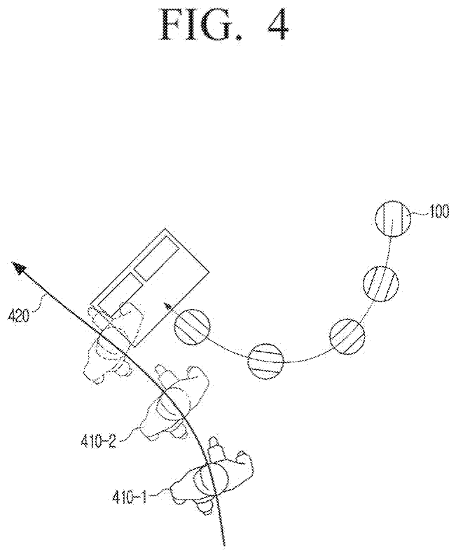

FIG. 4 is a diagram illustrating a process of identifying a predicted moving path of an electronic apparatus according to one or more embodiments.

According to an embodiment, the electronic apparatus 100 may identify a predicted moving path 420 of the user based on real time locations 410-1, 410-2 and a moving direction of the user sensed through the sensor 110.

According to an embodiment, the electronic apparatus 100 may identify the moving direction of the user based on the real time locations 410-1, 410-2 of the user. According to an embodiment, the electronic apparatus 100 may identify the moving direction based on the direction of the torso of the user. According to an embodiment, the electronic apparatus 100 may identify the moving direction based on the direction of the user's face. According to an embodiment, the electronic apparatus 100 may identify the moving direction based on the direction of the feet.

Referring to FIG. 4, the electronic apparatus 100 may identify the real time locations 410-1, 410-2 of the user based on sensing data sensed through the sensor 110. The electronic apparatus 100 may identify the moving direction of the user based on the sensing data.

In case an obstacle (e.g., furniture, a wall) was identified in the space, the electronic apparatus 100 may identify the predicted moving path 420 of the user based on the real time locations 410-1, 410-2 and the moving direction of the user, and the location of the obstacle.

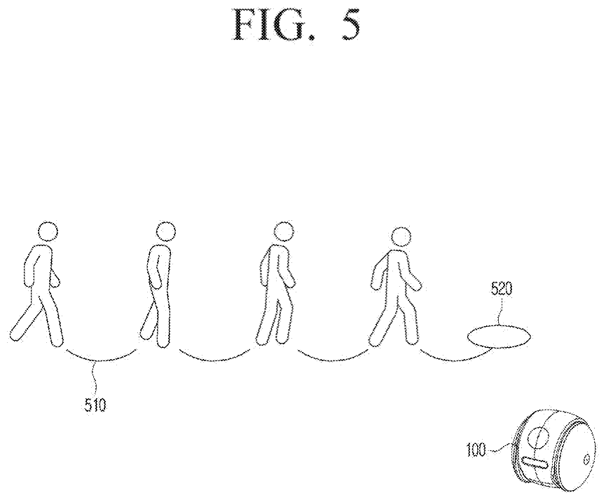

FIG. 5 is a diagram illustrating a process of identifying a walking pattern of a user an electronic apparatus according to one or more embodiments.

According to an embodiment, the electronic apparatus 100 may identify a walking pattern of the user based on the location of the feet of the user sensed through the sensor 110. The electronic apparatus 100 may identify a stride 510 of the user and a motion range of the feet, and identify the walking pattern of the user based on the stride 510 and the motion range of the feet.

According to an embodiment, the electronic apparatus 100 may identify the stride 510 and the motion range of the feet based on any one foot between the user's two feet. For example, the electronic apparatus 100 may identify a stride of the user 75 cm based on the right foot of the user. In this case, the electronic apparatus 100 may identify a location distanced from the current location of the user by 75 cm based on the moving direction of the user on the predicted moving path as a predicted location 520 of the user.

The electronic apparatus 100 may obtain a projection location based on the predicted location 520 of the user. As an example, the electronic apparatus 100 may obtain a predetermined range from the predicted location 520 of the user as the projection location.

Referring to FIG. 5, the electronic apparatus 100 may identify a walking pattern of the user based on the stride 510 of the user and the motion range of the feet by identifying the real time location of the user and the location of the feet through the sensor 110. The electronic apparatus 100 may identify the predicted location 520 of the user based on the identified walking pattern.

The electronic apparatus 100 may identify a projection location for projecting the UI screen based on the identified predicted location.

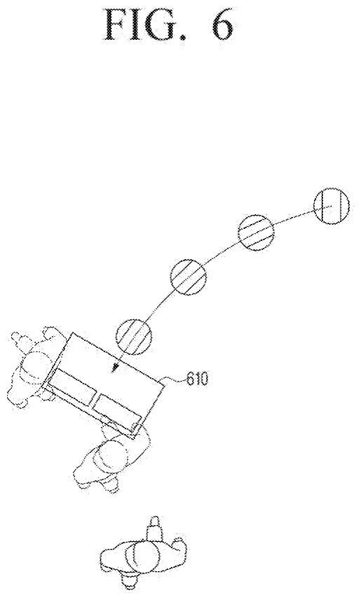

FIG. 6 is a diagram illustrating a process of identifying a projection location of a UI screen of an electronic apparatus according to one or more embodiments.

According to an embodiment, the electronic apparatus 100 may obtain a projection location 610 for projecting the UI screen through the projector 120 based on the walking pattern and the predicted moving path 420 of the user.

The electronic apparatus 100 may identify a predicted location of the user on the identified predicted moving path, and obtain an area or a location within a predetermined range based on the predicted location as the projection location. The projection location 610 for projecting the UI screen may be an optimal location for performing a foot interaction with the UI screen by using the user's foot. For example, the projection location 610 for projecting the UI screen may be a location distanced from the predicted location of the user by 10 cm based on the moving direction of the user.

According to an embodiment, if it is identified that the user stopped while moving along the predicted moving path, the electronic apparatus 100 may move to the location where the user stopped, and project the UI screen through the projector 120. In contrast, in case the user is keeping moving without stopping, the electronic apparatus 100 may obtain the projection location 610 based on the walking pattern, and move to the obtained projection location and project the UI screen through the projector 120.

Referring to FIG. 6, the electronic apparatus 100 may identify a predicted location of the user based on the walking pattern and the predicted moving path of the user, and obtain the identified predicted location as the projection location 610. The electronic apparatus 100 may move to the obtained projection location and project the UI screen through the projector 120.

According to an embodiment, the electronic apparatus 100 may transmit a control signal to an external display device so as to output a UI screen for a foot interaction through the external display device. The electronic apparatus 100 may transmit a user interface (UI) corresponding to the UI screen for a foot interaction to the external display device. The electronic apparatus 100 may transmit a control signal to the external display device so as to output the UI screen for a foot interaction through a display of the external display device.

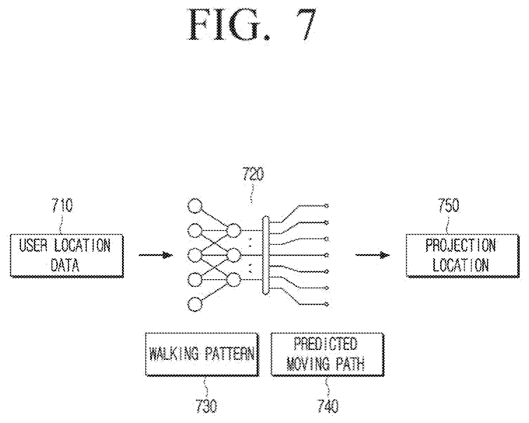

FIG. 7 is a diagram illustrating a process of identifying a projection location by using an artificial intelligence model of an electronic apparatus according to one or more embodiments.

According to an embodiment, the electronic apparatus 100 may obtain a projection location 750 by inputting location data 710 of the user sensed through the sensor 110 into an artificial intelligence model 720. The location data 710 of the user may include data regarding a real time location of the user and data regarding a moving direction of the user.

According to an embodiment, the artificial intelligence model may be a model that was trained to identify a walking pattern and a predicted moving path of the user based on the location and the moving direction of the user, and obtain a projection location based on the walking pattern and the predicted moving path of the user.

Here, the feature that the artificial intelligence model is trained means that a basic artificial intelligence model (e.g., an artificial intelligence model including random parameters) is trained by using a plurality of training data by a learning algorithm, and a predefined operation rule or an artificial intelligence model set to perform a desired characteristic (or, a purpose) is thereby made. Such learning may be performed through a separate server and/or a system, but embodiments of the disclosure are not limited thereto, and the learning may also be performed at the electronic apparatus 100. As examples of learning algorithms, there are supervised learning, unsupervised learning, semi-supervised learning, or reinforcement learning, but learning algorithms are not limited to the aforementioned examples.

Here, the artificial intelligence model may be implemented as, for example, a large language model (LLM), a convolutional neural network (CNN), a recurrent neural network (RNN), a restricted Boltzmann Machine (RBM), a deep belief network (DBN), a bidirectional recurrent deep neural network (BRDNN), or deep Q-networks, etc., but is not limited thereto.

Referring to FIG. 7, the electronic apparatus 100 may obtain the projection location 750 for projecting the UI screen by inputting the user location data 710 including the real time location data of the user and the moving direction data of the user into the artificial intelligence model 720. The artificial intelligence model 720 may identify a walking pattern 730 and a predicted moving path 740 of the user based on the real time location data of the user and the moving direction data of the user, and output the projection location 750 based on them.

The electronic apparatus 100 may move to the projection location obtained through the artificial intelligence model 720, and project the UI screen on the projection location through the projector 120.

FIG. 8 is flowchart and FIG. 9 is a diagram illustrating a process of identifying a dominant foot of an electronic apparatus according to one or more embodiments.

According to an embodiment, the electronic apparatus 100 may apply a weight to each of the two feet of the user based on a foot interaction use pattern, and if a weight for a first user foot between the two feet of the user reaches a predetermined threshold value, identify the first user foot as the dominant foot.

According to an embodiment, the electronic apparatus 100 may apply at least one of a first weight, a second weight, or a third weight to the first user foot based on the foot interaction use pattern. If a weight value applied to the first user foot reaches the predetermined threshold value, the electronic apparatus 100 may identify the first user foot as the dominant foot.

According to an embodiment, in case a single button for performing a foot interaction is included in the UI screen, the electronic apparatus 100 may apply the first weight to the user's foot that interacts with the single button. For example, the first weight may be +1.

According to an embodiment, in case a plurality of buttons for performing a foot interaction is included in the UI screen, the electronic apparatus 100 may apply a second weight to the remaining foot excluding a foot located to be adjacent to a first button interacting with the first button among the plurality of buttons. For example, the second weight may be +2.

According to an embodiment, in case an adjustable UI for performing a foot interaction is included in the UI screen, the electronic apparatus 100 may apply a third weight to the user's foot interacting with the adjustable UI. The adjustable UI is a slide-type UI for adjusting a volume or brightness, and may be a UI that needs a fine interaction process. For example, the third weight may be +3.

The aforementioned first weight value, second weight value, and third weight value are merely an example, and the weight values are not limited thereto. Also, according to a type of a UI, different weight values can be applied.

According to an embodiment, the electronic apparatus 100 may apply a weight to each of the two feet of the user based on the first weight, the second weight, and the third weight.

Referring to FIG. 8, in operation 810, the electronic apparatus 100 may project a foot interaction UI screen to the user through the projector 120.

In operation 811, the electronic apparatus 100 may identify whether a single button is included in the UI screen.

In operation 812 (operation 811, Y), in case a single button is included in the UI screen, the electronic apparatus 100 may apply the first weight to the first user foot interacting with the button between the two feet of the user.

Referring to 910 in FIG. 9, in case the user interacts with the UI screen 910 including a single button with the right foot 940, the electronic apparatus 100 may apply a first weight 950-1 to the right foot 940 of the user.

In operation 813, if the weight value applied to the first user foot reaches a predetermined threshold value, the electronic apparatus 100 may identify the first user foot as the dominant foot. For example, the predetermined threshold value is +10, but is not limited thereto.

In operation 814 (operation 811, N), in case a single button is not included in the UI screen, the electronic apparatus 100 may identify whether a plurality of buttons are included in the UI screen.

In operation 815 (operation 814, Y), the electronic apparatus 100 may identify whether the user selected the first button among the plurality of buttons included in the UI screen by crossing the legs.

In operation 816 (operation 815, Y), in case a plurality of buttons are included in the UI screen, the electronic apparatus 100 may apply a second weight to the first user foot interacting with a button located in a diagonal direction from the first user foot among the plurality of buttons.

Referring to 920 in FIG. 9, in the UI screen 920 including the plurality of buttons, case the user interacts with the first button located in front of the left foot among the plurality of buttons with the right foot 940, the electronic apparatus 100 may apply a second weight 950-2 to the first user foot.

In operation 817 (operation 815, N), in case the user interacts with a button located in front of the first user foot among the plurality of buttons, the electronic apparatus 100 may not apply a weight to the first user foot. For example, in case the user interacts with a button located in front of the right foot with the right foot, the electronic apparatus 100 may not apply a weight to the foot.

In operation 818 (operation 814, N), the electronic apparatus 100 may identify whether an adjustable UI is included in the UI screen.

In operation 819 (operation 818, Y), in case an adjustable UI is included in the UI screen, the electronic apparatus 100 may apply a third weight to the first user foot interacting with the adjustable UI.

Referring to 930 in FIG. 9, in the UI screen 930 including the adjustable UI, in case the user interacts with an adjustable UI element with the right foot 940, the electronic apparatus 100 may apply a third weight 950-3 to the right foot 940 of the user.

In operation 820 (operation 818, N), in case an adjustable UI is not included in the UI screen, the electronic apparatus 100 may not apply a weight to any one foot between the user's feet.

In operation 821 (operation 813, Y), in case the weight applied to the first user foot is greater than or equal to the predetermined threshold value, the electronic apparatus 100 may identify (960) the first user foot as the dominant foot. For example, after performing the aforementioned operation repeatedly, in case the weight applied to the right foot of the user is +12, as it is greater than or equal to the predetermined threshold value (e.g., +10), the electronic apparatus 100 may identify (960) the right foot of the user as the dominant foot.

In operation 822, the electronic apparatus 100 may identify the location of the dominant foot, and provide a UI screen based on the location of the dominant foot.

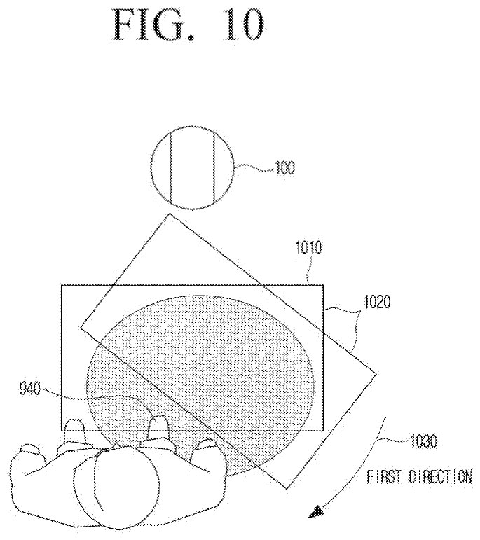

FIG. 10 is a diagram illustrating a process of identifying a projection area of a UI screen of an electronic apparatus according to one or more embodiments.

According to an embodiment, the electronic apparatus 100 may identify a first projection area 1010 based on the projection location and the location of the dominant foot. The first projection area 1010 may be an area that was set based on a motion range of the dominant foot based on the remaining foot excluding the dominant foot among the plurality of feet of the user.

In the case of a general common person, within a range of 45 degrees in an outward direction and 25 degrees in an inward direction based on the remaining foot excluding the dominant foot may be the motion range of the dominant foot.

According to an embodiment, the electronic apparatus 100 may identify a second projection area 1020 including an area that was rotated by a predetermined angle in a first direction 1030 with respect to the first projection area 1010 based on the first projection area 1010 and the dominant foot.

According to an embodiment, the first direction may be an outward direction of the dominant foot. For example, in case the dominant foot is the right foot, the first direction may be a clockwise direction, and in case the dominant foot is the left foot, the first direction may be a counter-clockwise direction.

According to an embodiment, the predetermined angle may be an angle that was set based on a motion range wherein a person can rotate based on one foot. For example, in case the dominant foot is the right foot, the first direction may be a counter-clockwise direction, and the predetermined angle may be 45 degrees.

According to an embodiment, the second projection area 1020 is an area including the first projection area 1010, and may be an area in a wider range than the first projection area 1010.

According to an embodiment, the electronic apparatus 100 may project a UI screen on one area in the second projection area 1020.

According to an embodiment, the electronic apparatus 100 may identify the height of the user through the sensor 110, and identify a UI screen in a first size based on the height of the user. The electronic apparatus 100 may project the UI screen in the first size centered around the location of the dominant foot on one area in the second projection area 1020. However, a method of identifying a UI screen in the first size based on the height of the user is not limited thereto, and it is obvious that a size of a UI screen can be identified through different methods.

Referring to FIG. 10, the electronic apparatus 100 may identify the first projection area 1010 based on the identified projection location and the location of the dominant foot 940. Specifically, the electronic apparatus 100 may identify the first projection area 1010 based on the motion range of the dominant foot. In case the dominant foot is the right foot, the electronic apparatus 100 may identify an area which is the first projection area rotated by a predetermined angle in the first direction 1030, i.e., a clockwise direction, and identify the second projection area 1020 including the identified area and the first projection area 1010.

The electronic apparatus 100 may project the UI screen in the first size on one area in the second projection area 1020.

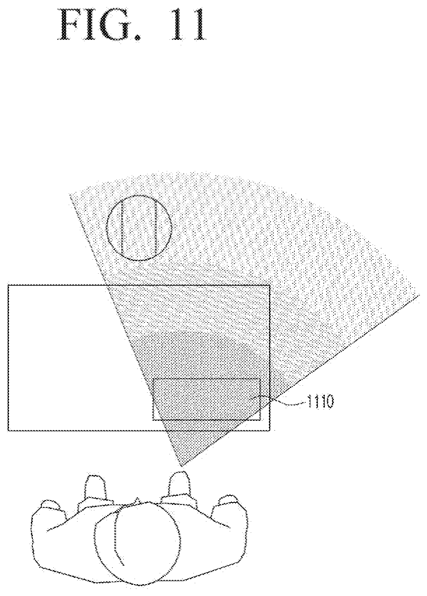

FIG. 11 is a diagram illustrating a method of projecting a UI screen including a single button of an electronic apparatus according to one or more embodiments.

According to an embodiment, in case a single button for performing a foot interaction is included in the UI screen, the electronic apparatus 100 may control the projector 120 to project a UI element 1110 corresponding to the single button on the center location of the dominant foot based on the location of the dominant foot.

According to an embodiment, the electronic apparatus 100 may project at least one UI element included in the UI screen through the projector 120 based on the location of the dominant foot. For example, in case a single button included in the previous UI screen is located in the center, the electronic apparatus 100 may adjust the projection location of the single button based on the identified location of the dominant foot.

Referring to FIG. 11, in case the dominant foot is the right foot, the electronic apparatus 100 may project a UI screen wherein the location of the single button 1110 included in the UI screen was adjusted from the center location to a right location through the projector 120. In contrast, in case the dominant foot is the left foot, the electronic apparatus 100 may project a UI screen wherein the location of the single button 1110 was adjusted to a left location through the projector 120.

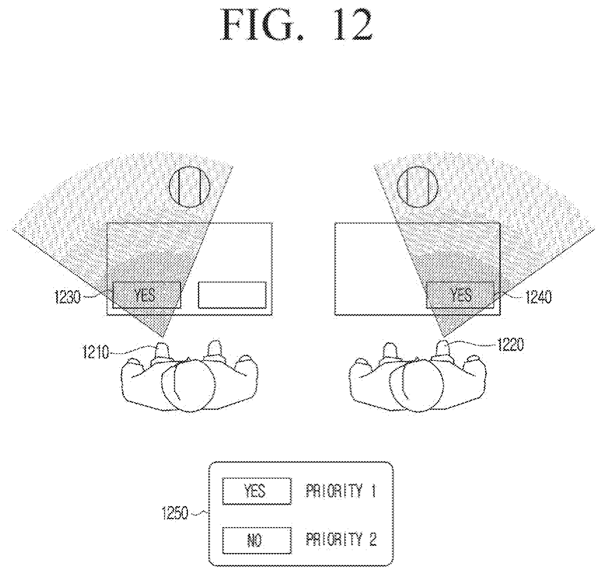

FIG. 12 is a diagram illustrating a method of projecting a UI screen including a plurality of buttons of an electronic apparatus according to one or more embodiments.

According to an embodiment, in case a plurality of buttons for performing a foot interaction is included in the UI screen, the electronic apparatus 100 may identify priority information 1250 regarding options included in each of the plurality of buttons based on a foot interaction use pattern. Here, the options may be general input words such as “YES,” “NO,” “SKIP,” etc.

According to an embodiment, the electronic apparatus 100 may identify the priority information 1250 regarding options based on log data selecting any one button among the plurality of buttons. For example, in case the user selected the option “YES” more between the options of “YES” and “NO,” the electronic apparatus 100 may identify that the priority for the option “YES” is higher.

According to an embodiment, the electronic apparatus 100 may control the projector 120 to project a button including an option having a high priority among the plurality of buttons on the center location of the dominant foot based on the location of the dominant foot.

Referring to FIG. 12, in case the dominant foot is the left foot 1210, the electronic apparatus 100 may project the UI screen such that a button 1230 including the option “YES” is located on the center location of the left foot 1210 based on the location of the left foot 1210. In contrast, in case the dominant foot is the right foot 1220, the electronic apparatus 100 may project the UI screen such that the button 1230 including the option “YES” is located on the center location of the right foot 1220 based on the location of the right foot 1220.

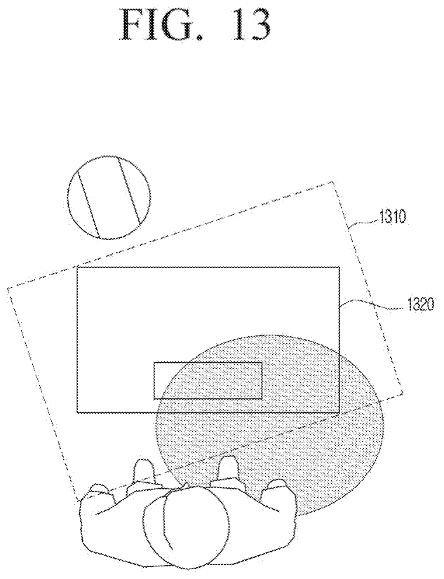

FIG. 13 is a diagram illustrating a process of adjusting a size of a UI screen of an electronic apparatus according to one or more embodiments.

According to an embodiment, in case an error occurred between an identified projection location and an actually projected projection location, the electronic apparatus 100 may control the projector 120 to project a UI screen 1320 wherein the size of the UI screen was adjusted on the identified projection area 1310.

According to an embodiment, the electronic apparatus 100 may project a UI screen in a smaller size than the first size on one area in the projection area 1310. The electronic apparatus 100 may adjust the direction of the UI screen, and project the UI screen on one area in the projection area 1310.

Referring to FIG. 13, the electronic apparatus 100 may project a UI screen 1320 whose size was adjusted within the projection area 1310 identified based on the location of the dominant foot. For example, the electronic apparatus 100 may project the UI screen 1320 whose size was adjusted in a smaller size than the first size on one area in the projection area 1310.

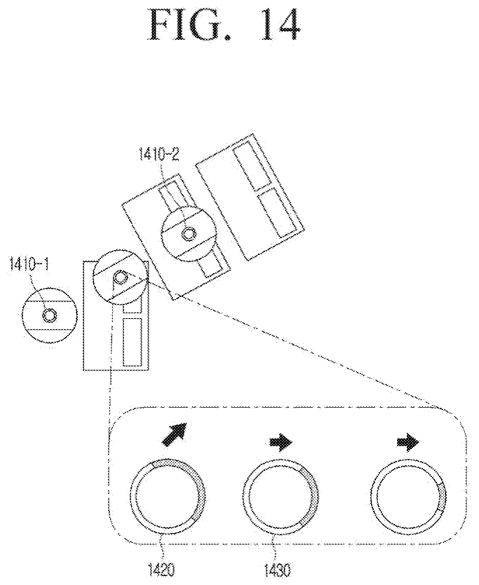

FIG. 14 is a diagram illustrating a process of providing information corresponding to time spent and a moving direction of an electronic apparatus according to one or more embodiments.

According to an embodiment, the electronic apparatus 100 may identify time spent that is spent in reaching a predicted location wherein the user will be located from the current location of the electronic apparatus 100 based on an identified predicted moving path.

According to an embodiment, the electronic apparatus 100 may provide a notification or information corresponding to the identified time spent and the moving direction to the user. The notification or information corresponding to the time spent and the moving direction may include information about the moving direction and information about the time spent.

According to an embodiment, the electronic apparatus 100 may further include an indicator for displaying information about a moving direction and information about time spent. As an example, the electronic apparatus 100 may provide information about a moving direction and information about time spent to the user through the indicator including LEDs. As an example, the electronic apparatus 100 may provide information about a moving direction and information about time spent to the user through a separate display part.

Referring to FIG. 14, the electronic apparatus 100 may identify time spent that is spent in reaching a predicted location wherein the user will be located from the current location, and display information corresponding to the identified time spent. For example, in case the time spent that was identified by the electronic apparatus 100 is 10 seconds, the electronic apparatus 100 may display information 1410-1 corresponding to time spent corresponding to 10 seconds, and in case the predicted location is adjacent, the electronic apparatus 100 may display information 1410-2 corresponding to time spent corresponding to three seconds.

In case the identified moving direction is the direction of 2 o'clock, the electronic apparatus 100 may display information 1420 corresponding to the moving direction corresponding to the direction of 2 o'clock. In case the identified moving direction is the direction of 3 o'clock, the electronic apparatus 100 may display information 1430 corresponding to the moving direction corresponding to the direction of 3 o'clock.

According to an embodiment, the electronic apparatus 100 may control the projector 120 based on a user voice signal received through the microphone 150. For example, if a user voice signal for projecting an UI is received, the electronic apparatus 100 may control the projector 120 to display the UI.

According to an embodiment, the electronic apparatus 100 may control an external display device connected with the electronic apparatus 100 based on a user voice signal received through the microphone 150. Specifically, the electronic apparatus 100 may generate a control signal for controlling the external display device such that an operation corresponding to the user voice signal is performed in the external display device, and transmit the generated control signal to the external display device. Here, the electronic apparatus 100 may generate a remote control application for controlling the external display device. Then, the electronic apparatus 100 may transmit the generated control signal to the external display device by using at least one communication method among Bluetooth, Wi-Fi, and infrared rays. For example, if a user voice signal for displaying an A content is received, the electronic apparatus 100 may transmit a control signal for controlling such that the A content is displayed on the external display device to the external display device. Here, the electronic apparatus 100 may mean various terminal devices wherein a remote control application can be installed such as a smartphone, an AI speaker, etc.

According to an embodiment, the electronic apparatus 100 may use a remote control device for controlling the external display device connected with the electronic apparatus 100 based on a user voice signal received through the microphone 150. Specifically, the electronic apparatus 100 may transmit a control signal for controlling the external display device such that an operation corresponding to the user voice signal is performed in the external display device to the remote control device. Then, the remote control device may transmit the control signal received from the electronic apparatus 100 to the external display device. For example, if a user voice signal for displaying an A content is received, the electronic apparatus 100 may transmit a control signal for controlling such that the A content is displayed on the external display device to the remote control device, and the remote control device may transmit the received control signal to the external display device.

According to an embodiment, the communication circuit 170 may use the same communication module (e.g., a Wi-Fi module) for communicating with an external device such as a remote control device and an external server.

According to an embodiment, the communication circuit 170 may use different communication modules for communicating with an external device such as a remote control device and an external server. For example, the communication circuit 170 may use at least one of an Ethernet module or a Wi-Fi module for communicating with the external server, and use a Bluetooth module for communicating with the external device such as a remote control device. However, this is merely an example, and the communication circuit 170 may use at least one communication module among various communication modules in the case of communicating with a plurality of external devices or an external server.

According to an embodiment, the electronic apparatus 100 may receive a user voice signal through the microphone 150 included in the electronic apparatus 100.

According to an embodiment, the electronic apparatus 100 may receive a user voice signal from an external device including a microphone. Here, the external device may mean a remote control device or a smartphone, etc. Here, the received user voice signal may be a digital voice signal, but depending on implementation examples, it may be an analog voice signal. The electronic apparatus 100 may receive a user voice signal through a wireless communication method such as Bluetooth or Wi-Fi, etc.

According to an embodiment, the electronic apparatus 100 may obtain text information corresponding to a user voice signal from an external server. Specifically, the electronic apparatus 100 may transmit a user voice signal (an audio signal or a digital signal) to an external server. Here, the external server may mean a voice recognition server. Here, the voice recognition server may convert the user voice signal into text information by using Speech To Text (STT). Then, the external server may transmit the converted text information corresponding to the user voice signal to the electronic apparatus 100.

According to an embodiment, the electronic apparatus 100 may obtain text information corresponding to a user voice signal by itself. Specifically, the electronic apparatus 100 may convert a digital voice signal into text information by applying a Speech To Text (STT) function by itself, and transmit the converted text information to the external server.

According to an embodiment, the external server may transmit text information corresponding to a user voice signal to the electronic apparatus 100. Specifically, the external server may be a server that performs a voice recognition function of converting a user voice signal into text information.

According to an embodiment, the external server may transmit at least one of text information corresponding to a user voice signal or search result information corresponding to the text information to the electronic apparatus 100. Specifically, the external server may be a server that performs a search result providing function of providing search result information corresponding to text information other than the voice recognition function of converting a user voice signal into text information.

As an example, the external server may be a server that performs both of the voice recognition function and the search result providing function. As another example, the external server may perform only the voice recognition function, and the search result providing function may be performed in a separate server. The external server may transmit text information to the separate server for obtaining a search result, and obtain a search result corresponding to the text information from the separate server.

According to an embodiment, the same communication module for communication with an external device and an external server may be implemented. For example, the electronic apparatus 100 may communicate with an external device by using a Bluetooth module, and may also communicate with an external server by using the Bluetooth module.

According to an embodiment, separate communication modules for communication with an external device and an external server may be implemented. For example, the electronic apparatus 100 may communicate with an external device by using a Bluetooth module, and may communicate with an external server by using an Ethernet modem or a Wi-Fi module.

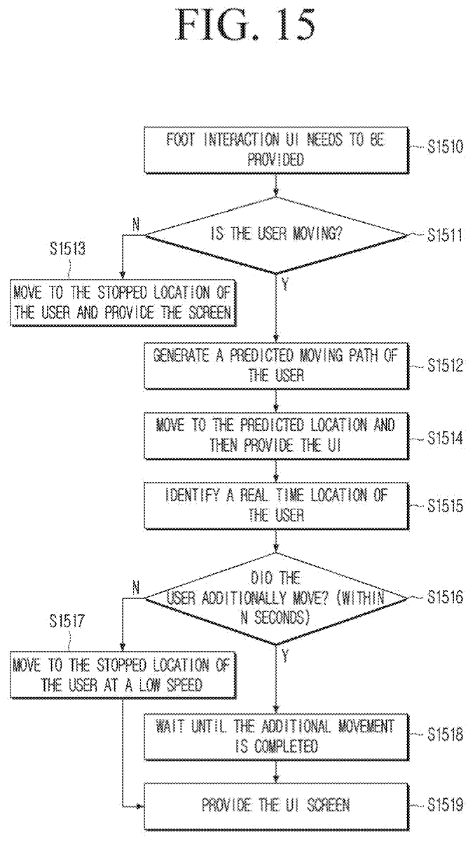

FIG. 15 is a flowchart illustrating a method of providing a UI screen of an electronic apparatus according to one or more embodiments.

Referring to FIG. 15, in operation 1510, in case a foot interaction UI screen needs to be provided to the user, the electronic apparatus 100 may identify the location of the user through the sensor 110.

In operation 1511, the electronic apparatus 100 may identify whether the user is moving through the sensor 110.

In operation 1512 (operation 1511, Y), if it is identified that the user is moving, the electronic apparatus 100 may identify a walking pattern and a predicted moving path of the user based on the location and the moving direction of the user identified through the sensor 110.

In operation 1513 (operation 1511, N), if it is identified that the user stopped, the electronic apparatus 100 may move to the location of the user and provide a UI screen.

In operation 1514, the electronic apparatus 100 may identify a predicted location of the user based on the walking pattern and the predicted moving path of the user, and move to the predicted location and provide a UI screen.

In operation 1515, the electronic apparatus 100 may identify a real time location of the user through the sensor 110, and identify the changed location of the user.

In operation 1516, the electronic apparatus 100 may identify whether the user additionally moved from the identified predicted location of the user.

In operation 1517 (operation 1516, N), in case an additional movement of the user not identified, the electronic apparatus 100 may move to the predicted location.

In operation 1518 (operation 1516, Y), in case an additional movement of the user was identified, the electronic apparatus 100 may wait until the additional movement is completed.

In operation 1519, the electronic apparatus 100 may provide a UI screen in the predicted location of the user (or the user location) that was finally identified.

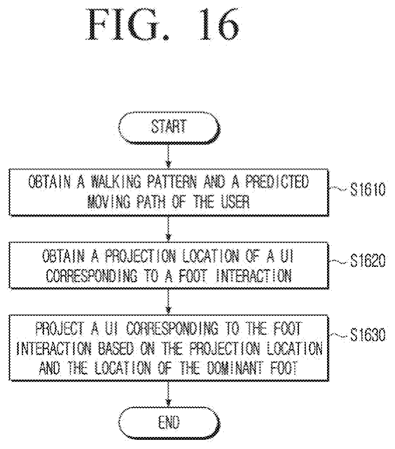

FIG. 16 is a flowchart illustrating a method of operating an electronic apparatus according to one or more embodiments.

Referring to FIG. 16, in operation 1610, if it is identified that the user is moving, the electronic apparatus 100 may obtain a walking pattern and a predicted moving path of the user based on the location and the moving direction of the user.

In operation 1620, the electronic apparatus 100 may obtain a projection location of a UI corresponding to a foot interaction based on the walking pattern and the predicted moving path of the user.

In operation 1630, the electronic apparatus 100 may project the UI corresponding t the foot interaction through the projector 120 based on the projection location and a location of a dominant foot.

The control method explained in FIG. 16 may be performed by the electronic apparatus 100 having the aforementioned configuration in FIG. 2, but is not limited thereto, and the control method may be performed by electronic apparatuses having various configurations.

Also, the aforementioned various embodiments may be implemented solely, or at least one embodiment may be combined with one another on the whole or partially, and implemented together in one device.

According to the aforementioned various embodiments, the electronic apparatus 100 can provide a UI screen in a more optimized location to the user based on a predicted location of the user and a location of a dominant foot.

The aforementioned various embodiments may be applied to a product solely, or the contents of at least some of them may be combined with other embodiments of the disclosure and implemented together.

The aforementioned various embodiments may be implemented as software or programs including instructions stored in machine-readable storage media, which can be read by machines (e.g., computers). The machines refer to apparatuses that call instructions stored in a storage medium, and can operate according to the called instructions, and the apparatuses may include an electronic apparatus according to the embodiments disclosed herein (e.g., the electronic apparatus 100). In case an instruction is executed by a processor, the processor may perform a function corresponding to the instruction by itself, or by using other components under its control. An instruction may include a code that is generated or executed by a compiler or an interpreter. Also, a storage medium readable by machines may be provided in the form of a non-transitory computer-readable storage medium. Here, the term ‘non-transitory’ only means that the storage medium does not include signals, and is tangible, and does not distinguish whether data is stored in the storage medium semi-permanently or temporarily.

Also, according to an embodiment of the disclosure, the method according to the aforementioned various embodiments may be provided while being included in a computer program product.

Specifically the method may include, based on identifying that a user is moving, obtaining a walking pattern and a predicted moving path based on a location and a moving direction of the user who is moving, obtaining a projection location of a user interface (UI) corresponding to a foot interaction based on the walking pattern and the predicted moving path, and projecting the UI corresponding to the foot interaction based on the projection location and a location of a dominant foot of the user, wherein the dominant foot of the user was obtained based on a use pattern obtained through performing of a function corresponding to the foot interaction.

A computer program product can be distributed on-line in the form of a storage medium that is readable by machines (e.g., compact disc read only memory (CD-ROM)), or through an application store (e.g., Play Store™). In the case of on-line distribution, at least a portion of a computer program product may be stored in a storage medium such as the server of the manufacturer, the server of the application store, and the memory of the relay server at least temporarily, or may be generated temporarily.

Also, computer instructions or programs for performing the control method for an electronic apparatus according to the aforementioned various embodiments may be stored in a non-transitory computer-readable medium. Computer instructions stored in such a non-transitory computer-readable medium make the processing operations at machines according to the aforementioned various embodiments performed by a specific machine, when the instructions are executed by the processor of the specific machine. A non-transitory computer-readable medium refers to a medium that stores data semi-permanently, and is readable by machines, but not a medium that stores data for a short moment such as a register, a cache, and memory, etc. As specific examples of a non-transitory computer-readable medium, there may be a CD, a DVD, a hard disc, a blue-ray disc, a USB, a memory card, ROM and the like.

In addition, while example embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. An electronic apparatus comprising:
a sensor;
a projector;
memory storing instructions; and
at least one processor including processing circuitry,
wherein the instructions, when executed by the at least one processor individually or collectively, cause the electronic apparatus to:
based on identifying that a user is moving, obtain a walking pattern and a predicted moving path based on a location and a moving direction of the user that are obtained through the sensor,
obtain a projection location of a user interface (UI) corresponding to a foot interaction based on the walking pattern and the predicted moving path, and
project, by the projector, the UI corresponding to the foot interaction based on the projection location and a location of a dominant foot of the user, and
wherein the dominant foot of the user is identified based on a use pattern obtained through performing of a function corresponding to the foot interaction.

2. The electronic apparatus of claim 1, wherein the instructions, when executed by the at least one processor individually or collectively, cause the electronic apparatus to:
obtain a first projection area based on the projection location and the location of the dominant foot of the user, and
project, by the projector, the UI on one area in a second projection area including an area that is rotated by a predetermined angle in a first direction with respect to the first projection area based on the first projection area and the dominant foot.

3. The electronic apparatus of claim 2, wherein the first direction is an outward direction of the dominant foot, and
wherein the instructions, when executed by the at least one processor individually or collectively, cause the electronic apparatus to:
identify a height of the user through the sensor, and
project, by the projector, a UI corresponding to a first size based on the height of the user on one area in the second projection area centered around the location of the dominant foot.

4. The electronic apparatus of claim 2, wherein the first projection area is based on a motion range of the dominant foot based on a remaining foot of the user, and
wherein the second projection area is wider than the first projection area.

5. The electronic apparatus of claim 1, wherein the instructions, when executed by the at least one processor individually or collectively, cause the electronic apparatus to:
apply a weight to each foot of the user based on the use pattern, and
based on the weight for a first foot of the user corresponding to a predetermined value, identify the first foot as the dominant foot.

6. The electronic apparatus of claim 1, wherein the instructions, when executed by the at least one processor individually or collectively, cause the electronic apparatus to:
based on a single button corresponding to a foot interaction being included in the UI, apply a first weight to a foot corresponding to the single button,
based on a plurality of buttons corresponding to a foot interaction being included in the UI, apply a second weight to a foot of the user, other than a foot adjacent to a first button, corresponding to the first button among the plurality of buttons, and
based on an adjustable UI corresponding to a foot interaction being included in the UI, apply a third weight to a foot of the user corresponding to the adjustable UI.

7. The electronic apparatus of claim 1, wherein the instructions, when executed by the at least one processor individually or collectively, cause the electronic apparatus to:
obtain the projection location through an artificial intelligence model based on data corresponding to a user location obtained through the sensor, and
wherein the artificial intelligence model is trained to obtain the walking pattern and the predicted moving path based on the location and the moving direction of the user, and obtain the projection location based on the walking pattern and the predicted moving path.

8. The electronic apparatus of claim 1, wherein the instructions, when executed by the at least one processor individually or collectively, cause the electronic apparatus to:
based on a single button corresponding to a foot interaction being included in the UI, project, by the projector, a UI corresponding to the single button on an area corresponding to a center location of the dominant foot.

9. The electronic apparatus of claim 1, wherein the instructions, when executed by the at least one processor individually or collectively, cause the electronic apparatus to:
based on a plurality of buttons corresponding to a foot interaction being included in the UI, obtain priorities corresponding to the plurality of buttons based on the use pattern, and
project, by the projector, a button having a high priority among the plurality of buttons on an area corresponding to a center location of the dominant foot.

10. The electronic apparatus of claim 1, wherein the instructions, when executed by the at least one processor individually or collectively, cause the electronic apparatus to:
obtain a time spent corresponding to a movement from a current location to a predicted location of the user based on the predicted moving path, and
provide a notification corresponding to the time spent and the moving direction.

11. A control method for an electronic apparatus, the control method comprising:
based on identifying that a user is moving, obtaining a walking pattern and a predicted moving path based on a location and a moving direction of the user that are obtained by a sensor of the electronic apparatus;
obtaining a projection location of a user interface (UI) corresponding to a foot interaction based on the walking pattern and the predicted moving path; and
projecting, by a projector of the electronic apparatus, the UI corresponding to the foot interaction based on the projection location and a location of a dominant foot of the user,
wherein the dominant foot of the user is identified based on a use pattern obtained through performing of a function corresponding to the foot interaction.

12. The control method of claim 11, further comprising:
obtaining a first projection area based on the projection location and the location of the dominant foot of the user; and
projecting, by the projector, the UI on one area in a second projection area including an area that is rotated by a predetermined angle in a first direction with respect to the first projection area based on the first projection area and the dominant foot.

13. The control method of claim 12, wherein the first direction is an outward direction of the dominant foot, and
wherein the control method further comprises:
identifying a height of the user through the sensor, and
projecting a UI corresponding to a first size based on the height of the user on one area in the second projection area centered around the location of the dominant foot.

14. The control method of claim 12, wherein the first projection area is based on a motion range of the dominant foot based on a remaining foot of the user, and
wherein the second projection area is wider than the first projection area.

15. The control method of claim 11, further comprising:
applying a weight to each foot of the user based on the use pattern; and
based on the weight for a first foot of the user corresponding to a predetermined value, identifying the first foot as the dominant foot.

16. The control method of claim 11, further comprising:
obtaining the projection location through an artificial intelligence model based on data corresponding to a user location obtained through the sensor,
wherein the artificial intelligence model is trained to obtain the walking pattern and the predicted moving path based on the location and the moving direction of the user, and obtain the projection location based on the walking pattern and the predicted moving path.

17. The control method of claim 11, further comprising:
based on a single button corresponding to a foot interaction being included in the UI, projecting, by the projector, a UI corresponding to the single button on an area corresponding to a center location of the dominant foot.

18. The control method of claim 11, further comprising:
based on a plurality of buttons corresponding to a foot interaction being included in the UI, obtaining priorities corresponding to the plurality of buttons based on the use pattern; and
projecting, by the projector, a button having a high priority among the plurality of buttons on an area corresponding to a center location of the dominant foot.

19. The control method of claim 11, further comprising:
obtaining a time spent corresponding to a movement from a current location to a predicted location of the user based on the predicted moving path; and
providing a notification corresponding to the time spent and the moving direction.

20. A non-transitory computer-readable storage medium storing computer instructions which, when executed by a processor of an electronic apparatus, cause the electronic apparatus to perform operations comprising:
based on identifying that a user is moving, obtaining a walking pattern and a predicted moving path based on a location and a moving direction of the user;
obtaining a projection location of a user interface (UI) corresponding to a foot interaction based on the walking pattern and the predicted moving path; and
projecting the UI corresponding to the foot interaction based on the projection location and a location of a dominant foot of the user,
wherein the dominant foot of the user is identified based on a use pattern obtained through performing of a function corresponding to the foot interaction.
